(19) United States
(12) Patent Application Publication
(10) Pub. No.: US 2008/0147257 A1
(43) Pub. Date: Jun. 19, 2008

(54) System and Method for Total Management of Ships

(75) Inventors: Klaus Kuhlgatz, Saarbrucken (DE); Michael F. Benzel, Eppelborn (DE)

Correspondence Address: YI LI, CUSPA TECHNOLOGY LAW ASSOCIATES, 11820 SW 107 AVENUE, MIAMI, FL, 33176, US

(73) Assignees: KLAUS KUHLGATZ, SAARBRUCKEN (DE); JORG BRITZ, SAARBRUCKEN (DE)

(21) Appl. No.: 11/885,790

(22) PCT Filed: Mar. 3, 2006
(86) PCT No.: PCT/EP2006/060459

§ 371 Date: Mar. 1, 2008

(30) Foreign Application Priority Data
Mar. 7, 2005 (CH) 00384/05

(51) Int. Cl. G06F 17/00; G06Q 10/00

(52) U.S. Cl. 701/21; 705/1

(57) ABSTRACT

The system consists of a central, stationary Tele Connect Centre (15) with stationary servers (14), software modules, databases and call centre (21) on land. The call centre on land contains all ship-specific data relevant for the management and the operation of the individual ships. Further, there are mobile communication platforms (16), which consist of a central unit (1), software modules and input interface/control panel (2) each, on the ships equipped with the system, each with antennae and power supply for 12/24 Volt supply for communicating via GSM, marine radio or satellite network with the stationary Tele Connect Centre (15). A process can be operated with this system, by which data transmitted from the mobile central unit (1) can be processed and maintained with the servers (14) as well as all types of data relevant for the management and operation of the ships can be provided in the corresponding databases, besides the ship-relevant ones. The data are exchanged in both directions round the clock by means of corresponding software modules according to regulated and requirement-wise cost-payable access authorisation.

The present invention is concerned primarily with a plant to totally manage a ship in general and a leased or chartered ship in particular. Secondarily, the invention is also concerned with the operation of this plant according to a specific technical process.

By total management of the ship, is understood not only the financial management but also the logistical, personnel and technical management, since such ships have to, for example, be provided with fuel, lubricants, with consumables or with repair parts as and when required. And the crew requires everything to be supplied, from drinking water, from foodstuffs to medicines to toilet articles and other things for the daily requirement. Besides that, maintenance instructions have to be observed for all engineering facilities, which belong to the ship. However, not only the purely technical maintenance is included in this management but also the effective operation with all its technical aspects. Therefore, the navigation, for instance, plays a central role as well as the weather forecast and its interpretation, and further also includes the management of the technical usage of all sea and air rescue equipments. Finally, the technical support and help for the preparation and handling of passing through difficult passages and harbour entrance also belong to this, including all aspects in connection with the use of ports and landings. That includes for instance the technical communication with the relevant officials and operators of these equipments as well as with customs officials and the exchange of technical, operational and touristic information carried out for that.

The problems connected with the management of ships are shown here based on an example of the management of a yacht, which is leased or chartered together with a crew. First of all a yacht must be managed in the sense that its reservation must be administered. Here, still many things are done manually. A call is made, reserved, the reservation is confirmed and afterwards the ship is provided with the next crew. It would be helpful if all potential users could look into the reservation plan and all the technical information of many different yachts online and could finally process reservations online along with the necessary advances.

Besides the reservation plan and the technical data of the boat and its outfit, a potential customer should be able to retrieve many other information in connection with a desired or planned sailing trip online from the charter supplier. These are information about the port location, where the yacht can be taken over, like infrastructure equipments of the port, its qualities and special features (type and number of berths, parking areas, tidal differences, technical service stations, port officials, customs officials, etc.), also purchase options, general restaurants, tourist information on hotels, car rental, close by airports and railway stations with flight schedules and timetables, information on cultural issues and attractions, on weather and climatic conditions on land and sea, etc. Though some of these information can be retrieved online on the Internet, they cannot be found centrally and concentrated at one place—and consequently a laborious and time-consuming gathering together of all relevant data is necessary.

The charter customer wants to be able to retrieve all data in connection with the planned sailing trip from the supplier. The reservation of a yacht in a particular port at a particular time and for a particle duration including the payment must also be possible online. At the same time, the customer should also be able to assemble the entire outfit in excess of the basic equipment, which he requires additionally for a sailing trip, by a click of the mouse. If the customer himself cannot be or does not want to be the skipper, it should be possible to arrange for a skipper along with the possibly needed crew. If the customer does not want to worry about the stashing away of foodstuffs and fresh water, he should be able to order this also directly online. Further, the customer should be able to compile and print out sensible sailing trip routes with ports of call, anchorages and correlated weather and climate charts during the preparation at home. The charter supplier must be able to offer all these additional services around the actual sailing trip directly and online.

In addition, the customer is also interested in the present exact location of his desired yacht, in fact also if the yacht is at present still on high seas en-route with another crew. Till today, the suppliers of charter yachts can make only approximate indications about the actual positions of their boats, which are based on the indications of the respective crews which reaches the head office with delay of hours to days, if at all.

The problem of the present invention is to provide a system and a process for the total management of ships, with which all problems listed above are solved.

This problem is solved on the one hand by a system according to the independent equipment claim 1 and on the other hand by a process according to the independent process claim 7.

The system is represented schematically in the drawings with all its essential technical elements and is described afterwards based on these drawings and its functioning and the process operable with the system is explained and clarified.

The figures show:

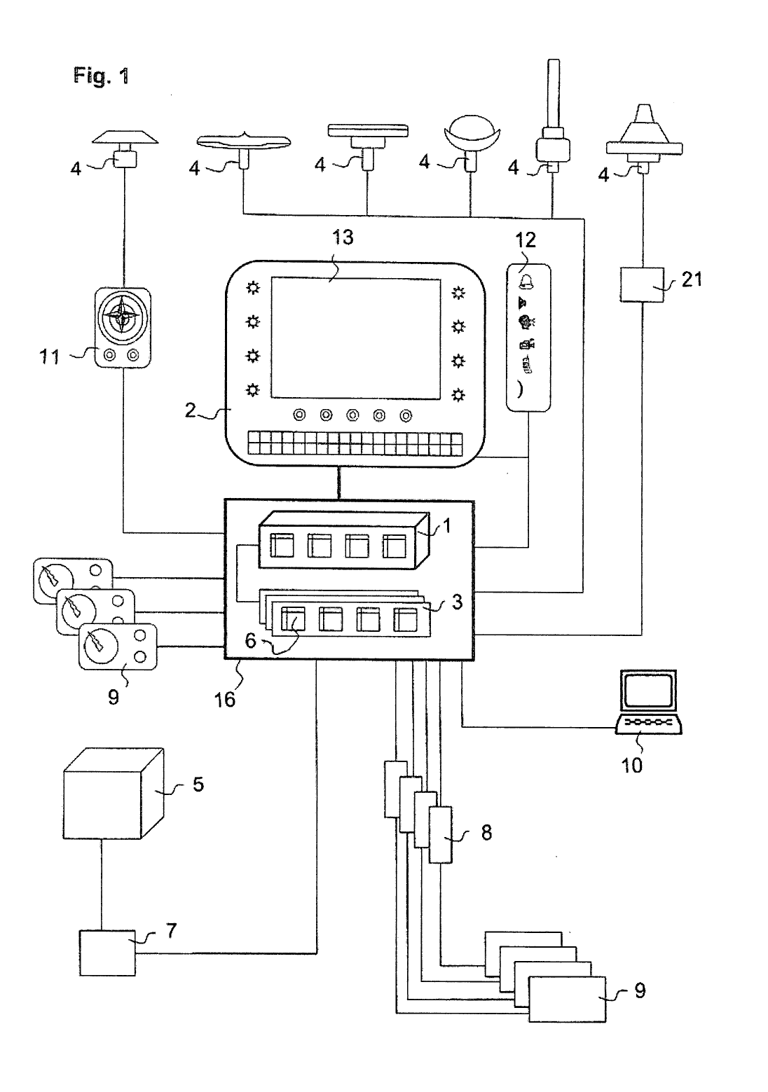

FIG. 1: A schematic representation of the mobile central unit 1 with control panel 2 on an individual ship and with possible connections to peripheral devices;

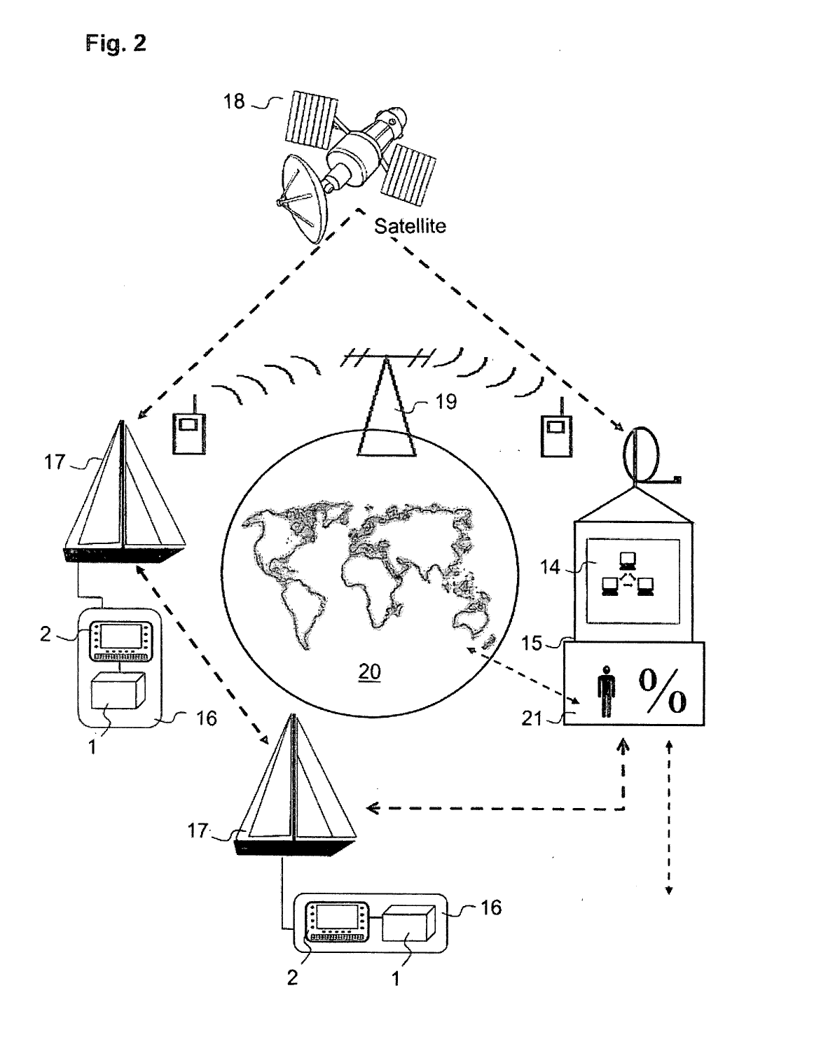

FIG. 2: A schematic representation of all system components for the operation of the process consisting of the mobile central unit 1 and control panel 2 on the ships and the stationary Service-Connect Centre 15 on land.

A mobile communication platform 16 is shown in schematic representation in FIG. 1 as is housed on each equipped ship. The embodiment consists of a central unit 1 with all necessary outputs and inputs (interfaces), in which there is the possibility to network the central unit 1 with several extension modules 3, if required. Thus, an extension module 3 can, for example, be configured as intelligent interface to the connection to the on-board system so that active ship components like rudder and hydraulics can be controlled with that. The second important element of the communication platform 16 is the control panel 2 consisting of an LCD Touchscreen Display 13, rotating knobs and input keys. The yacht skipper communicates primarily via control panel 2, which portrays all information on the screen 13. In addition to that, the control panel 2 also serves for the communication, in which the yacht skipper can enter data, both by touchscreen as well as by the input keys or through a connectable computer mouse. A complete multimedia station (Email, SMS, MMS, Video telephony, etc.) emerges through connecting of multimedia devices like photo and film camera, telephone etc. The central unit 1 can be connected to measuring sensors 8 and to nautical devices 9, radar 11 or also with an external Laptop 10 to all common interfaces (like USB, Serial, Ethernet, NMEA, CAN etc.). The central unit 1 processes the available data and represents these on the display 13 of the control panel 2. It is very important that they contain different tailor-made software modules 6, which are necessary on one hand to process the available data from the peripheral devices and on the other hand to ensure complete communication to the control panel 2 as well as to the Service Connect Centre on land by GSM, marine radio or satellite communication. The central unit 1 makes available the necessary interfaces to connect various antennae 4 (like GPS, VHF, UKW, Satellite Network IRIDIUM, Inmarsat C Satellite Communication arrangement, Marine radio etc.). Further, the central unit 1 is connected to a power supply unit 5 and a correlated alarm unit 7. The alarm unit serves for the monitoring of the system and the electrical circuit.

A schematic representation of all components for the operation of the system is portrayed in FIG. 2. The on-board communication platform 16, consisting of the mobile central unit 1 and the control panel 2, remains in connection with the Tele Connect Centre 15 on land via GSM 19, marine radio and satellite communication 18. The Connect Centre 15 consists of one or more server stations 14, which contain the corresponding software modules, and a service centre (call centre) 21, where employees receive, forward and process the incoming questions, requests and problems of the yacht skipper on sea round the clock. Also, the fleet management can take place from this centre as all ships are constantly in touch with the Connect Centre. Preferably, several call centres 21 are operated distributed around the globe so that minimum one can be operated in daytime. All important technical data of the fleet are received here and can be managed centrally at one place. The converging data deliver to the fleet manager important decision-making assistance, which jobs are pending, when, for which ship, since the ship-relevant data are transmitted permanently by the system, which is installed on each ship belonging to the fleet. The process is operated by the logical operation of the mobile communication platform 16, formed out of central unit 1, software modules 6 installed on it and control panel 2 as well as the stationary Connect Centre 15, consisting of server 14, databases, software modules and a call centre 21. A further important part of the process is that different ships of the fleet can also communicate with each other via GSM, radio or satellite, which is very helpful, for example, for a concerted Atlantic crossing of several ships of a charter. Thus, all participants always know about the condition and the position of the other ships and their crew decision and information, tips etc. can be exchanged with each other at any time. Also, the fleet manager on land in the Connect Centre has the relevant data and the position of each of his ship involved in this regatta. He can transmit important information to all ships together at the same time.

The professional supplier of charter yachts as well as the charter customers require different additional data and information in addition to the information already mentioned for an active fleet management and the remote maintenance of the yachts or for their direct operating on sea. These are made available through a plant, which, as shown in FIG. 2 schematically in totality, consists of a central, stationary service station 15 with servers 14 and corresponding software and a communication box 16 installed on each boat, with which a bi-directional data transfer can take place via marine radio, GSM and satellite communication, that is round the clock. The central unit 1 (Interface) with control panel 2 (LCD Display 13 with input functions via knobs and by touchscreen) is connected to the different technical measuring sensors 8, nautical electronic devices 9 and different transmitting and receiving antennae 4 (VHF, UKW, GPS, INMARSAT, etc.) through the corresponding interfaces (USB, Serial, Ethernet, NMEA, CAN etc.) and contains different software applications 6. It consequently forms a central communication unit 16 and allows the supplier to know at any time the current position of all his ships, irrespective of whether these are now in a port, on open sea or on land in a shipyard for overhauling. The central unit 1 with the associated control panel 2 is an all-in-one device that allows retrieval of all available data to save, to analyse, to evaluate and to represent graphically. Such data are not limited only to ship-related information but on the contrary, not only data prepared by the service station 15 (Connect Centre 21/Server 14), but also, in principle, all data material present on the Internet are available via GSM, marine radio and satellite. The connection to the Internet enables naturally also the use of services like Email, multimedia, video telephony, SMS, MMS, MP3 etc. The supplier or the crew can retrieve and represent all relevant technical data via the sensors 8, which are connected to the central unit 1 on the boats. These can be, e.g., telemetric data like position, voyage and direction of the ship, weather data like air and water temperature, humidity, barometric reading with forecast, wind speed and direction, data for the fuel stock and other engine-specific information, data about the fresh water stock, the charge condition of the batteries, data on the power supply, data on the type and area of the sails, ocean depth, heeling of the ship etc. Naturally, the communication to the ship or to the crew can also be made any time, which can be via Email/Internet, GSM and satellite telephony or via marine radio, according to the position of the yacht on sea—this applies naturally also in the reverse direction for the crew on sea to the service station on land. The transmission of multimedia data (picture, film and sound) is also possible in both directions between base station and yacht without any problem with this plant.

It is possible for the charter supplier or fleet owner to have an accurate overview about the technical status of all his ships at any time through the intelligent linking of the mobile communication box 16 to corresponding sensors 8 and measuring devices 9 and to corresponding transmission and antenna systems 4 on the ship, which guarantee the data transfer between ship 17 and the central server 14. Through this intelligent fleet management, the owner always knows when, which ship must be technically maintained, refueled, overhauled, when the next service of the diesel engine is due, which equipments and fittings have to be replaced after a certain operating period, etc. A proactive, intelligent, cost-efficient and lean fleet management can be implemented through that. Through that, the yachts and boats present in a fleet are no more intangible satellites, but are clearly defined and controlled units and are virtually “glass ships”. The use of the ships can be reproduced and planned beforehand such that an enormous saving in time also results, where the idle times between sailing trips is small and consequently the efficiency of the fleet management is increased.

The use of the plant and the process operated with it also performs very valuable services for the customer from his arrival on the ship, if the planned sailing trip is prepared properly. The central unit 1 in the communication box 16 installed on the ship, connected to a control panel 2, delivers to the skipper all important and necessary information, which is required for the optimal preparation of his individual sailing trip. On the one hand, the skipper can retrieve all local, relevant data, like, for example, information on the port where the ship is, on the local infrastructure units, on opening times of local shopping centres, stores, restaurants etc. But, the skipper must also carry out planning-related tasks before the sailing, which is very much simplified through the communication box 16. The communication box 16 delivers all important data on the meteorology with forecasts for the next day, creates weather charts as also electronic nautical chart, calculates possible routes etc. and waypoints can be entered by a mouse click. The itinerary is created quickly with the entry of the departure time and the average speed and the probable arrival time at each waypoint is automatically calculated. The dynamic representation of weather images (wind, air pressure, wind sea, wave height, swell), the graphical representation of weather conditions and weather warnings are also available 24 hours a day. Weather forecasts are possible up to 5 days in advance. Weather data are transmitted by the central service station 15 by radio to the mobile central unit 1 and represented on the electronic nautical chart. Thus, route plans can be automatically calculated depending on the weather conditions. All images and charts can be printed out with a connected output device like printer or plotter.

Ship-related data are also determined permanently by means of the central unit 1 and displayed on the control panel 2. The current status of the technical condition of the ship is available to the skipper at any time through that. He knows the present outfit with stowing location, he knows immediately where the life-saving safety equipments are, knows the current position of the fresh water and diesel stock and can also, if desired, retrieve at any time operating and repairing instructions for all technical devices on the ship. Further, he can make contact with land by radio with the central service station 15 to solve problems with the help of experts and to clarify questions. Medical care is also ensured round the clock through that. The communication box 16 delivers to the skipper important information on that and also creates, if necessary, the direct connection to a doctor or shows where the nearest hospital and doctors can be found locally. The resource management of the foodstuffs can also be monitored through the central unit 1 and controlled. The purchased foodstuffs are registered by barcode reader before stashing away, the same applies for the withdrawal and the consumption. Thus, the information box 16 can indicate at any time the position of the foodstuff stock, hint on expiration data or also give recommendations on meal times and recipes specially tailored for sailing trips. Thus, the costs of the consumption of foodstuffs can also be entered directly online and calculated. Naturally, alarms can also be generated, if the stock of the foodstuffs falls below a definite value or the shelf-life date has elapsed. It is therefore possible for the skipper or the boat owner to be involved to a great extent in service and security provisions through the presence of this communication box 16 on the ship.

When all preparations are completed, a checklist can be run-down by a dialog by means of the communication box 16 before going on the sea, so that the skipper has the security that nothing was centrally forgotten. As soon as the yacht sets sail, the central unit 1 on the ship measures constantly the important, relevant data and remains always in connection with the stationary control room 15 on the mainland, that is the server 14 in the service station 21, by GSM, satellite or marine radio and delivers to the skipper continuously all required information. The central unit 1 on the ship monitors all security-relevant data and is programmed in such a way that the control functions trigger an alarm as soon as a certain value is exceeded or fallen below. This information is represented on the control panel 2 clearly. Engine data like diesel stock, oil level, hours operated, consumption, next maintenance service etc. can be displayed on pressing a button. The central unit 1 can be connected to different measuring sensors 8, such that the monitoring, also the supervision of the boat or, e.g., in the case of cargo ships, their cargo also, is ensured. In this way, measurement data about cargo shortages, inert gas pressure, steam pipeline pressure, cargo temperature, pressure and temperature of the cargo pipes, draft, trim and list, level of ballast and service tank, inert gas pressure in headspaces, pressure of ballast pump and pipe, valve and pump control, which play an important role, can be monitored continuously. Also a fire alarm system, consisting of smoke-, ionisation-, heat-, flame-, optical and manual alarm, can be connected to the central unit 1, such that an early fire recognition—especially even for smoldering fires—is possible and the alarm is guaranteed.

Other technical devices and measuring sensors can also be directly controlled and retrieved via the central unit, as shown in FIG. 1. Thus, e.g., a radar 11 (with range, bearing, electronic cursor, echo amplification, watch mode, with receiving set for AIS signals), an echo sounder 9 (with shallow water and profundities calibrations, fish finder and anchor watch) and a compass 9 (e.g. Fluxgate steering compass with digital display and fully gimbal-mounted sensor) can be connected. The meteorological data can be likewise represented on the control panel 2 by central unit 1 as also internal and external temperature, humidity and dew point, wind-chill, wind direction and speed (with apparent wind), barometer with weather forecasts, phases of the moon, rainfall and rate, hygrometer and tide display.

The central unit 1 functions also as briefcase computer with sm/km recording, speeds, speed through water (Log), completed and remaining voyage duration (calculated) (daily miles and total miles), it displays solar/lunar times and calculates the current tidal data and currents valid for the instantaneous position, which are particularly very important inshore. Further functions and alarms like TracBack, MOB (Man over Board), GOTO are available. Weather data can be displayed on the control panel 2 by central unit 1 similar to Navtex through a separate, own information system, which, besides navigation warnings, transmits SOS and rescue reports, among others are weather reports as well as storm and strong breeze warnings. The ocean lane record occurs automatically with some thousand waypoints storage capacity, where the position of the ship 17 is recorded continuously by means of WAAS-capable GPS (WMS=Wide Area Augmentation System according to US Standard) and/or EGNOS-capable GPS (EGNOS=European Geostationary Navigation Overlay Service) for accurate position determination. The central unit 1 calculates from all the available data the necessary course according to the target of the skipper. The central unit 1 records the data and generates an electronic logbook, which is transmitted to the central service station continuously. Moreover, this logbook can be looked into and printed out by the crew anytime, be it directly from a memory on the ship or from a central service station, so that there is a redundancy. All data of the integrated 14-channel GPS receiver are displayed on the screen 13 of the control panel and can be represented on electronic chart systems, which are based on the current technology for screen nautical charts (like e.g. C-Map™NT plus or NT MAX), and printed out on a nautical chart plotter, if required.

The central unit 1 on the ship is connected to a modern UKW marine radio system, by means of which modern UKW communication and the security of the global GMDSS emergency call system (GMDSS=Global Maritime Distress and Safety System) is implemented in a device with integrated DSC-D-Controller (Digital Selective Calling). The digital selective call enables direct radio contact to ships, coastal radio station and, in case of see distress, the emergency call with indication of the position and the ship identity (MMSI=Maritime Mobile Service Identity). The exact position of the ship is determined automatically in combination with the existing GPS thanks to the ATIS and DSC functions (Digital Selective Calling) together with the emergency call. The marine radio enables not only terrestrial radio communication but also radio communication via satellites for the transmission of private and ship-service information between radio stations on land and radio stations on ship as well as between radio stations on ships. The radio-service with ship stations performs an important contribution to the ensuring of the security of the navigation and for the protection of human life on sea. It is the basis of the global maritime distress and safety system (GMDSS). Rescue apparatus radio stations and radio buoys for the indication of the emergency position are component of this radio service. The present communication box 16 with central unit 1 allows the communication from the ship both by GSM, marine radio as well as by satellite (Satellite Network IRIDIUM) and likewise the permission criteria (SOLAS—Safety of Live At Sea) for the radio beacon (radio buoy, distress-at-sea beacon) can be fulfilled. The distress-at-sea beacon is based on EPIRP (Emergency Position Indicating Radio Beacon), a security system installed on ships, which marks the position of a ship in case of emergency. The transmitted signals are received by an international satellite system for search and rescue system (COSPAS-SARSAT), the position is determined and forwarded to the earth stations. In addition to that, aircrafts and ships can also receive the signals and locate the emergency position (Homing). The EPIRP is activated either manually or through a water pressure trigger.

It is also possible that the central unit 1 is connected to a satellite telephone, which uses the satellite network IRIDIUM. The IRIDIUM network guarantees a genuine, worldwide radio network cover for satellite telephones, and it offers in addition unique roaming equipments for many existing telephone systems. Moreover, the central communication box 16 also has corresponding interfaces to link to a fully GMDSS-compatible Inmarsat C transceiver, which enables the fast and reliable communication connections via “Digital Ship Earth Station” (SES), which agrees with the Inmarsat C system specifications and the GMDSS requirements. A fast, reliable and worldwide 2-way telex-, Email- and data transfer is thus guaranteed.

It happens very often that a crewmember becomes sick or is injured during a sailing trip. Till now, the crew was mainly self-dependent or had to gather medical knowledge from books on board laboriously. Medical help can be received immediately and specifically through the permanent communication path via central unit 1 to the stationary Connect Centre 15, since the service centre 21 provides all necessary medical information and, if necessary, also works directly together with doctors. It is also possible to instruct the crew on board one to one by means of video telephony through multimedia communication for complicated medical cases, e.g. for a leg fracture, so as the best way to proceed in this case now, i.e. the doctor on land in the Connect Centre 15 shows the crew step by step how the broken leg has to appear and what all has to be done otherwise in order to bring the patient safely to the next port. Even lifesaving emergency interventions are also possible, which could not be carried out or only under great risk without the system according to the invention. Naturally, all necessary measures can be already initiated on high seas, which are necessary for the quick recovery of the patient. The central unit 1 delivers information on the nearest ports, which could be called, together with the optimal course calculated beforehand, distance (GOTO Function/Wayfinder) and probable duration and arrival time. The Connect Centre 21 can call up ambulances and doctors immediately on arrival of the yacht and inform the hospital in advance.

Minor sea damages and technical defects on board unfortunately are part of almost every long high sea sailing trip. In spite of the best preparation and high quality materials, engines can break down, devices do not function anymore, leakages occur, bilge pumps break down, the boom or mast can break etc. In such cases, the help through the system proposed here is guaranteed, thus all necessary information can be fetched via Connect Centre 15. The operating and repairing instructions for all equipments present on the ship and the engine can be looked into, portrayed and printed out. Just as in the case of a medical emergency, in these cases also the situation can be analysed with an expert by video telephony and a problem can be removed in a step by step process under his able guidance. If damage cannot be removed by the crew, the system supplies information as to how and where the repair is possible. The system also delivers in this case the best, optimal routes with calculated voyage duration and arrival at the next port. Necessary spare parts can be ordered beforehand. If necessary, a replacement vessel can also be organised or hotel room and flights can—while at sea—be booked.

Now, if the yacht skipper wants to anchor at an approaching island or call at a ship's harbour after successful voyage, the central communication box 16 offers very valuable help. The yacht skipper can get in touch with the service centre 15 any time and obtain the necessary and current information and data—thus he need not collate data in (obsolete) books laboriously for long, which generates uncertainties and loss of time. He can especially undertake a booking of the berth early, long before he enters the port. Programmable chip cards are made available by charterers, which enable the access to all the facilities of the marina. This means that the procurement of the berth does not require the visit of the Capitanerie any more in order to receive a key or a chip card for the sanitary areas in the port. These cards are programmed online by the call centre directly with the berth allocation for the respective period. That offers extremely significant benefits: There is no more language problems in understanding and the crew is no more bound to some office opening times of the Capitänerie. In many marinas, the locking systems were already replaced by such chip card systems. If this is not the case, the call centre arranges suitable offers for the conversion so that the personnel can be saved. If the yacht skipper wants to anchor before an island, the necessary detailed charts can be loaded on the operating device 2 together with the indication of good anchorages under consideration of the relevant current meteorological and nautical data. The system includes an automatic anchor watch, which registers any change of position of the anchored ship and triggers an alarm in case of selectable large changes. The anchorage search and piloting can be graphically represented so that a safe crossing of difficult passages is also possible. The Connect Centre 15 also delivers all information on the island, which the skipper requires, so that a safe anchoring is guaranteed. Additionally, touristic data on the island can be received, its population and culture, on restaurants etc. The same process can also be applied also for the entry into a port. The central unit 1 delivers the important data on the technical port facilities, shows where free anchorages are available for new arrivals, shows the spatial conditions of the port, where the customs officials are, it offers a specific checklist, where the necessary entry facilities are filled and, if necessary or desired, the automatic piloting up to the landing is also possible.

When the yacht is in the port safely, all the information, which are demanded and required, can be retrieved, graphically represented and printed out by means of the central unit 1 and the control panel 2 as already at the beginning of the sailing trip in the home port (Starting port). Hotel, taxi, rented car or flight reservations can be made easily and quickly. The skipper can do this independently since he checks the Internet or he can call the Connect Centre 15 and give his requirements, which are then fulfilled for him promptly. Also spare parts for the ship, new sails, repair services etc. can thus be ordered, if this was not already done on high seas before entering port. The ordering, purchasing, paying and stashing away of new foodstuffs and fresh water occurs in the same elegant method as this has been already carried out for the home port before the start of the sailing trip. All these tasks are very much simplified by means of the central communication unit 1. Also, the cost management always remains transparent since all service costs generated during the sailing trip are always present ready for retrieval. The communication box 16 also gives information about the technical condition of the ship, like operating hours of all important engineering facilities, necessary pending services or repairs. These information are particularly very important for the fleet manager, who must make the ship again afloat for the next crew and the next sailing trip. The central unit 1 delivers to him exact data for that and proposes all necessary measures. It has to be mentioned again that the fleet manager need not be on site, but can have his location anywhere on earth 20, since the technical data can be retrieved by GMS, marine radio or satellite communication. Consequently, the technical management of a fleet is very easy since the data of all existing ships converge centrally, independent of where the individual ships and the control centre are. The central unit and the process operable with that are completely global and can be used independent of each other space-wise, but however form a unit such that the business model Tele Connect System (TCS) is possible. The related service provisions are charged to the customer—he can retrieve the costs anytime on the ship, so long as the sailing trip lasts. After the end of the sailing trip, the relevant data, including all costs of the sailing trip made, can be retrieved online by entry of the customer number and the password and paid online. The charterer sets a corresponding portion of the deposit paid beforehand.

The process enables a greatly improved fleet management by permanent monitoring of all important data of the moving ship and consequently a rational, lean and cost-effective management of the fleet through better utilisation and shorter idle and repair times in ports or shipyards. The process therefore leads to a considerable increase in the added value of the fleet and offers on the other hand a considerably improved service and a new form of safety on sea.

1. System for the total and permanent economical and technical management and operation of ships, consisting of a central, stationary Tele Connect Centre (15) with stationary servers (14), software modules and databases, containing all ship-specific data relevant for the management and operation of the individual ships, and a call centre (21) on land and consisting of mobile communication platforms (16) on the ships serviced with the system, with central unit (1), software modules (6) and input-interface/control panel (2) each, with antennae (4) and power supply for 12/24 Volt supply (5) for the communicating via GSM, marine radio or satellite network (IRIDIUM) with the stationary Tele Connect Centre (15), where data transmitted from the mobile central unit (1) can be processed and maintained with the servers (14) as well as ship-independent data of all types relevant for the management and operation of the ships can be provided in the corresponding databases, and that the data can be exchanged round the clock in both directions by means of corresponding software modules according to regulated and requirement-wise cost-payable access authorisation.

2. System for the total and permanent economical and technical management and operation of ships according to claim 1 characterised by the fact that each mobile, that is, central unit (1) installed on the ship is networked with additional extension modules (3), which contain tailor-made software applications (6) like the central unit (1) and are configured as intelligent interfaces for the connection to the on-board electrical system and by means of which active ship components like rudder and hydraulics can be controlled.

3. System for the total and permanent economical and technical management and operation of ships according to one of the claims 1 or 2 characterised by the fact that each mobile, that is, central unit (1) installed on the ship has extension modules (3) and interfaces, through which measuring sensors (8), nautical devices (9, 11), external computers/laptops (10), multimedia devices, antenna systems and transmitting systems (4) can be connected.

4. System for the total and permanent economical and technical management and operation of ships according to one of the claims 1 to 3 characterised by the fact that the control panel (2) connected to the central unit (1) is an input interface and consists of LCD Display (13) with touch screen, turning knobs, input keys and interfaces for computer mouse and multimedia devices.

5. System for the total and permanent economical and technical management and operation of ships according to one of the claims 1 to 4 characterised by the fact that the central unit (1) is fitted with an alarm unit (7), which is connected to the 12/24V power supply (5), and by means of which the entire system can be monitored as voltage monitoring.

6. System for the total and permanent economical and technical management and operation of ships according to one of the claims 1 to 5 characterised by the fact that at the minimum following data can be exchanged between the Tele Connect Centre (15) and the individual ships by GSM, marine radio and satellite in both directions:
Telemetric data for navigation like position with speed and direction, waypoints, average speed, calculated arrival time
Trackback, MOB, GOTO
GMDSS emergency call, MMSI number, EPIRP
Data for medical help
Data for the bilge, bilge umps
Fuel stock
Fresh water stock, foodstuff stock, stock of materials
Charge status condition of the power supply (Batteries)
All operation-relevant technical data of the ship
All relevant data for the (Diesel) engine
All data and localisation for the fitting out of the ship
All data for the navigation
Weather data and forecasts for particular routes
Dynamic representation of weather images (Wind, Air pressure, Wind sea, Wave height, Swell), graphical representation of weather situation, weather warnings and weather forecasts
Local actual data of the ship about air and water temperature, humidity, barometric reading with forecast, wind speed and direction
Actual data of the ship for type and area of the set sails, ocean depth, heeling
Actual data of the ship for sonar, radar
Ship voyage-specific infrastructure data about ports and landings
Reservation and booking plans of all yachts of a fleet
Electronic payment handling
Touristic information on the port location and landings and infrastructure data like hotels, airports, railway stations, restaurants
Reservations and booking service for all types of services
Image, sound and document transmission (Multimedia) in different formats

7. Process for the total and permanent economical and technical management and operation of ships with a central, stationary Tele Connect Centre (15) with stationary servers (14), software modules, databases and call centre (21) on land as well as mobile communication platforms (16) consisting of central unit (1), software modules (6) and input interface (2) on the ships, each with antennae (4) and power supply for 12/24 Volt supply (5) for communicating via GSM, marine radio or satellite network with the stationary Tele Connect Centre (15), in which the servers (14) existing therein contain all ship-specific data relevant for the management and operation of the individual ships and process and maintain data transmitted from the mobile central unit (1) as well as provide all types of data relevant for the management and operation of the ships in relevant databases besides the ship-relevant ones and that the data are exchanged round the clock in both directions by means of corresponding software modules according to regulated and requirement-wise cost-payable access authorisation.

8. Process for the total economical and technical management and operation of ships according to claim 7 characterised by the fact that the stationary Tele Connect Centre (15) on the servers (14) maintain specially conceived software applications and databases, whose data are fetched from the mobile central units (1) and which process the technical measurement data delivered by the mobile central units (1) and integrate the databases and software applications for the further communication.

9. Process for the total economical and technical management and operation of ships according to one of the claims 7 to 8 characterised by the fact that contact is maintained with the mobile central units (1) installed on the ships from the stationary Tele Connect Centre (15) through personnel via one or more manned Connect call centres (21) round the clock and data, voice and images are exchanged in both directions, in which these data can originate both from the central servers, databases and software applications as well as from third sources and specialists consulted.

10. Process for the total economical and technical management and operation of ships according to one of the claims 7 to 9 characterised by the fact that following data are exchanged between the stationary Tele Connect Centre and the individual ships by GSM, marine radio and satellite in both directions:
Telemetric data for navigation like position with speed and direction, waypoints, average speed, calculated arrival time
Trackback, MOB, GOTO
GMDSS emergency call, MMSI number, EPIRP
Data for medical help
Data for the bilge, Bilge pumps
Fuel stock
Fresh water stock, foodstuff stock, stock of materials
Charge status condition of the power supply (Batteries)
All operation-relevant technical data of the ship
All relevant data for the (Diesel) engine
All data and localisation for the fitting out of the ship
All data for the navigation
Weather data and forecasts for particular routes
Dynamic representation of weather images (Wind, Air pressure, Wind sea, Wave height, Swell), graphical representation of weather situation, weather warnings and weather forecasts
Local actual data of the ship about air and water temperature, humidity, barometric reading with forecast, wind speed and direction
Actual data of the ship for type and area of the set sails, ocean depth, heeling
Actual data of the ship for sonar, radar
Ship voyage-specific infrastructure data about ports and landings
Reservation and booking plans of all yachts of a fleet
Electronic payment handling
Touristic information on the port location and landings and infrastructure data like hotels, airports, railway stations, restaurants
Reservations and booking service for all types of services
Image, sound and document transmission (Multimedia) in different formats
